(19) United States
(12) Patent Application Publication
(10) Pub. No.: US 2019/0280641 A1
(43) Pub. Date: Sep. 12, 2019

(54) PORTABLE SOLAR POWER SYSTEM

(71) Applicant: Keith Owen, Franklin, NC (US)

(72) Inventor: Keith Owen, Franklin, NC (US)

(21) Appl. No.: 16/351,048

(22) Filed: Mar. 12, 2019

Related U.S. Application Data
(60) Provisional application No. 62/641,692, filed on Mar. 12, 2018.

(51) Int. Cl. H02S 10/40; F24S 30/45; F24S 50/20; H02S 20/32; H02S 30/20; F24S 20/50; H02J 7/35; H02J 7/00

(52) U.S. Cl. CPC H02S 10/40; F24S 30/45; F24S 50/20; H02S 20/32; F24S 2025/012; F24S 20/50; H02J 7/355; H02J 7/0052; H02S 30/20

(57) ABSTRACT

A portable solar power system is disclosed. The system includes a wheeled support and transport platform with a center mast. Secured to the mast is a panel system comprising at least two solar panels, which may be folded into a stable and aerodynamic upwardly extending position for transportation. The mast, by means of at least one slewing drive, allows for rotation and positioning of the solar panels for maximum sun exposure.

The current application is related to U.S. Provisional Patent Application Ser. No. 62/641,692, filed on Mar. 12, 2018.

### FIELD OF THE INVENTION

The invention as described herein relates to a portable solar power system.

### BACKGROUND

The invention relates generally to an apparatus that provides mobile energy generation through the use of solar panels.

Many nations place high importance on renewable energy sources to eliminate or mitigate dependence on fossil fuels. According to Bloomberg New Energy Finance, global markets invested more than $332.1 billion in clean energy investment in 2018. As compared to 2017 spending, this figure is down at least in part due to the sharply declining capital costs in the solar energy sector, meaning that solar energy is becoming less expensive and, thus, a more readily obtainable energy source.

While the access to electricity increases each year throughout the world, many rural areas remain without access. The International Energy Agency reports that fourteen percent of the world's population reside in areas where electricity is not available and even more do not have consistent, high quality access to electricity. More than ninety-five percent of those living without electricity are in countries in sub-Saharan Africa and developing Asia.

While standalone portable solar power systems are available, their availability is both limited and expensive. Moreover, such systems are often not designed for aerodynamic transportation or for effectively tracking the sun. Portable solar systems designed for deployment at locations with varying terrain conditions and topographies are also difficult to find while also meeting the need for effective sun tracking and true portability.

### SUMMARY OF THE INVENTION

According to an aspect of an embodiment of the invention disclosed herein, the portable solar power system comprises a panel system, a panel manipulation system, and a transport platform.

The panel system comprises two sets of solar panels. For maximum energy collection, two sets of four panels may be the most desirable choice, though sets of one, two, three, five, or even more may be preferred for certain applications. The sets of solar panels shall be securely attached to a support system for attaching the panels to each other and to the panel manipulation system. The support system may incorporate hinges such that each set of solar panels is hingably attached to the other set on a single axis, permitting them to be fully expanded so that they provide an effectively flat surface or to be folded into an upwardly extending position (i.e., inverted V shape), with each set of solar panels on either side. When the sets of solar panels contain more than one panel each, certain of the solar panels within the sets may also be hingably attached such that they may fold atop one another. For example, when incorporating eight solar panels in the system, the outer four panels may fold atop the inner four panels.

The portable solar power system shall further comprise a panel manipulation system. The panel manipulation system comprises at least one slewing drive, a panel system axle that passes through the center of a slewing drive and is attached to the support system, and a mast. The slewing drive or drives shall allow for easy manipulation of the position of the set of solar panels to allow for ideal capturing of solar energy. This first slewing drive shall be vertically affixed to a mast that is appropriately sized and constructed to properly support the panel system in a variety of positions. In some embodiments, a second slewing drive may be incorporated to provide additional positioning options for the panel system. The panel system axle shall secure the panel system to the first slewing drive. In certain embodiments, the panel system axle itself serves as the hinge that attaches half the solar panels to the other half of the solar panels, permitting them to be folded along a single axis into an upwardly extending position (i.e., inverted V shape). The mast shall be secured to the transport platform of the portable solar power system.

The transport platform of the portable solar power system comprises a wheeled support and transport platform with a substantially three-dimensional trapezoidal or pyramidal base approximately centered atop the deck of the transport platform. Use of a wheeled trailer is ideal inasmuch as it allows for easy transportation of the portable solar power system by hitching the trailer to a towing vehicle. Fixing one or more outriggers to the wheeled trailer frame provides additional stability when the portable solar power system is immobile through broadening the base of the system as well as providing for leveling. Tie downs may also be desirable depending on weather conditions.

The mast, which is connected at the top to the solar panels via the slewing drive and the support system, passes through at least a portion of the base to allow excellent stability for the overall system by providing at least two points of connection for the mast with the base. The mast may be secured either to the deck of the trailer or to a plate within an upper portion of the trapezoidal base, allowing the lower portion of the trapezoidal base to be used for storage. The storage area is ideally located for convenient storage of an energy storage system and equipment necessary to connect the portable solar power system to an external attachment that will make use of the energy, and the weight of any items stored in this area will further increase stability of the portable solar power system.

### BRIEF DESCRIPTION OF THE DRAWINGS

The accompanying drawings, which are incorporated in and constitute part of the specification, illustrate embodiments of the invention and, together with the description, serve to explain the principles of the invention.

FIG. 1 shows a side perspective view of a portable solar power system with deployed solar panels.

FIG. 2 depicts a rear perspective view of a portable solar power system in transportation mode.

FIG. 3 shows a rear perspective view of a portable solar power system with deployed solar panels in a diagonal orientation.

FIG. 4 depicts a side perspective view of a portable solar power system with deployed solar panels in a diagonal orientation.

FIG. 5 shows a top perspective view of a portable solar power system with deployed solar panels effectively parallel to the ground.

FIG. 6 depicts an exploded view of a single solar panel and support structure components of a portable solar power system.

FIGS. 7 and 8 depict end views of a set of structural support rods attached to support struts.

FIG. 9 shows an exploded detail view of an inner structural support rod and two outer structural support rods.

FIG. 10 depicts a perspective view of a slewing drive and a hinged panel system axle.

### DETAILED DESCRIPTION OF THE DRAWINGS

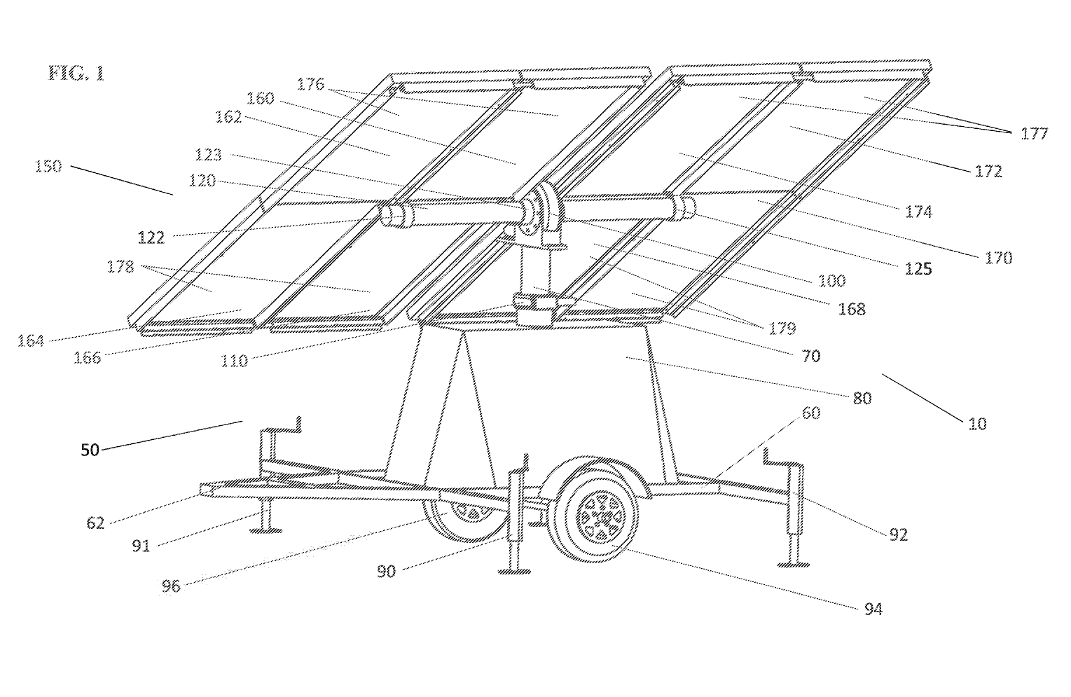

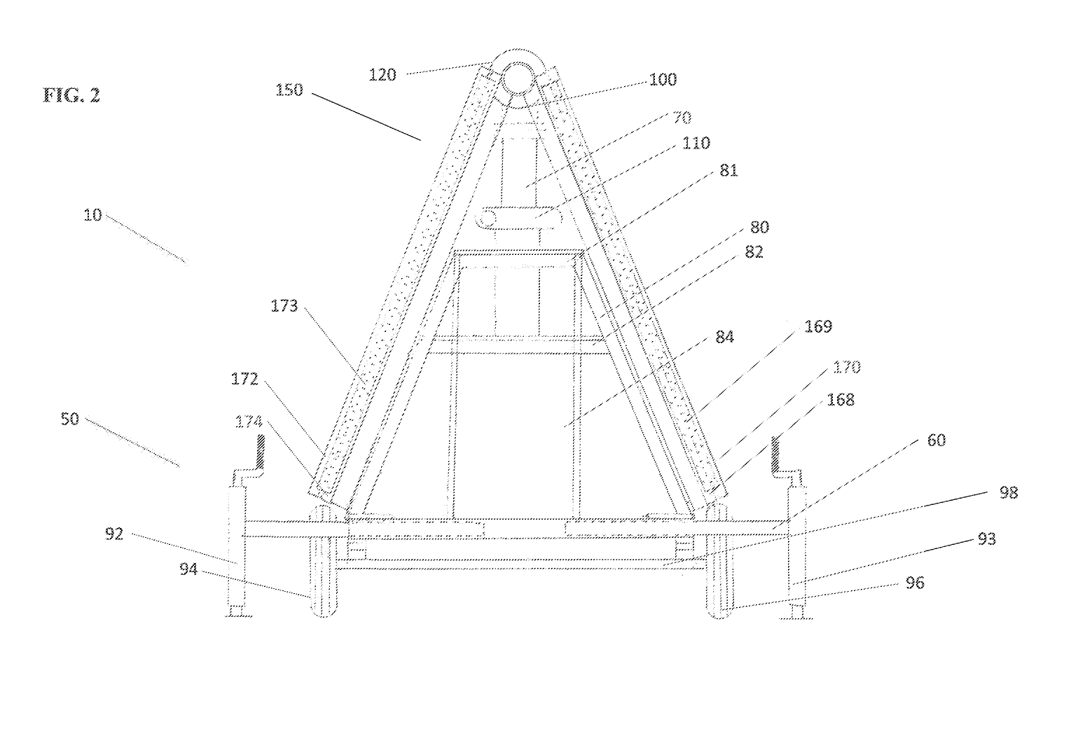

FIG. 1 is a simplified perspective view illustrating a portable solar power system 10 according to an embodiment of the disclosure. Certain components of the portable solar power system 10 are better illustrated in the additional FIGS. 2-10. The portable solar power system 10 comprises a transport platform 50, a panel manipulation system, and a panel system 150.

The transport platform 50 comprises a trailer having a deck 60 with a hitch 62 set upon wheels 94, 96 connected by an axle 98. The trailer is contemplated as being a standard utility trailer having a width of five to six feet and a length of eight to twelve feet, though other sizes may be used depending on the desired energy capacity of the portable solar power system 10, the limitations of a vehicle that would tow the portable solar power system 10, or other factors. The deck 60 should be manufactured of suitable materials and design such that it can safely and securely support and transport the rest of the portable solar power system 10. The hitch 62 would allow for easy transportation of the portable solar power system 10 through connection to a towing vehicle. One or more outriggers 90, 91, 92, 93 may be incorporated for providing additional stability for the portable solar power system 10 depending on weather or terrain conditions when the panel system 150 is deployed or when simply parking the portable solar power system 10.

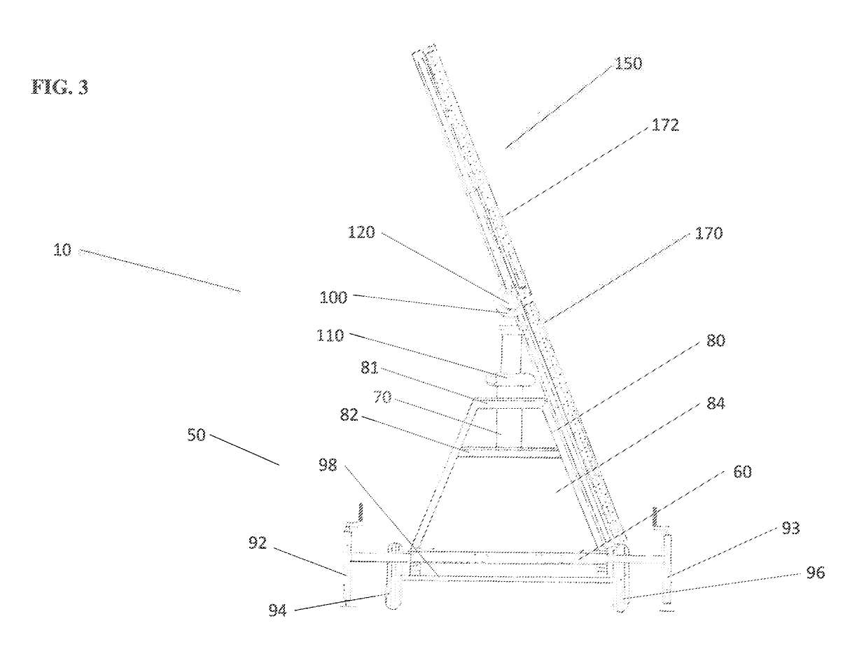

As more fully seen in FIGS. 2-3 as well as in FIG. 1, the transport platform 50 includes a base 80 that is attached to the top of the deck 60. The base 80 as depicted is trapezoidal in shape, though a pyramid shape would also be effective. Due to a low center of gravity, three-dimensional trapezoids and pyramids are of the most structurally stable shapes. The broader the lower portion of the base 80 in relation to the deck 60, the greater the overall stability will be for the portable solar power system 10. The base 80 may comprise a storage area 84 within its interior such that a user may store any number of things, including, for example, a battery, set of batteries, or other energy storage system for storing energy generated by the portable solar power system 10. The weight of any items placed in the storage area 84 will further increase stability of the portable solar power system 10.

A panel manipulation system connects the transport platform 50 of the portable solar power system 10 to the panel system 150. The panel manipulation system comprises a mast 70, one or more slewing drives 100, 110, and a panel system axle 120 and is attached to the support system of the panel system 150. The panel system axle 120 may itself be a tube-on-tube hinge for hingably attaching the panel manipulation system to the panel system 150. The hinged panel system axle 120 will necessarily have a plurality of hinge connectors which fit together to form the hinge. The embodiment depicted in FIGS. 1, 4, and 10 reflect the use of four hinge connectors 122, 123, 124, 125, though other configurations may be used as well. For some embodiments, a suitable hinged panel system axle 120 may comprise two sections, with each section having a flat, leaf portion and a set of knuckles to fit the two sections together, and a pin to slide through the knuckles to join the two sections. Half of the panel system 150 would be attached to one hinge section, and the other half of the panel system 150 would be attached to the second hinge section. In other embodiments, a suitable hinge may be a pinless continuous hinge such as a geared hinge. A pinless hinge comprises a joint piece into which the barrel portion along the edge of each of two leaves may be inserted. Half of the panel system 150 would be attached to one leaf, and the other half of the panel system 150 would be attached to the second leaf.

The mast 70, which is primarily column-like in shape, extends from the base 80 upward to connect with and support the panel system 150. As depicted in FIGS. 2-3, the mast 70 may pass through the center of the top plate 81 of the base 80. The mast 70 may extend into the upper portion of the interior of the base 80 and be attached at its base to a mast support plate 82 above the storage area 84. While this two-point connection for the mast 70 is not required, it is preferred to provide additional stability to the mast 70. If further stability is desired and the storage area 84 is not desired, the mast 80 may extend all the way through the base 80 and the mast support plate 82 may be attached to or comprised of the deck 60.

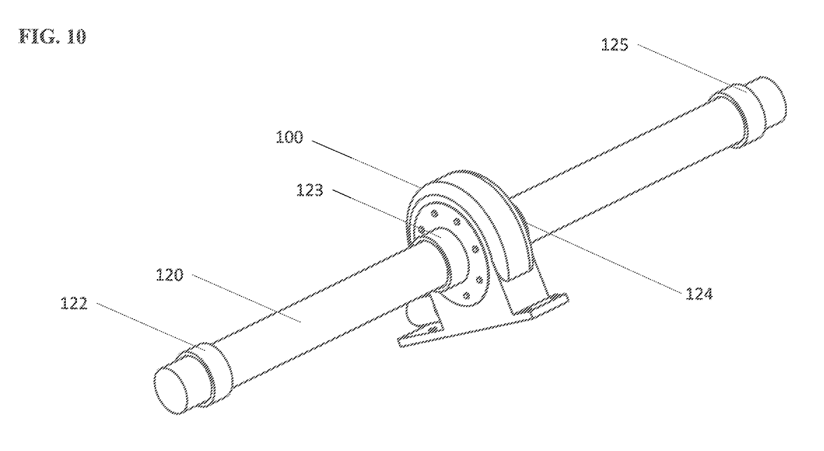

The embodiment depicted in FIGS. 1-4 reflect incorporation of two slewing drives 100, 110. The first slewing drive 100 is vertically mounted to the top of the mast 70. As may be seen more clearly in FIG. 10, a hinged panel system axle 120 may pass through the center of the first slewing drive 100 and is attached to the panel system 150 such that the panel system 150 may be at least radially manipulated by the slewing drive 100.

The slewing drive 100 may be either single or dual-axis, both of which offer significant improvement over a fixed system due to the ability to more accurately track the sun's course as the earth rotates. Should the slewing drive 100 be dual-axis, this will provide for a turning range of up to 350 degrees, allowing for the greatest opportunity for solar energy collection through sun tracking. In embodiments in which the slewing drive 100 is single-axis, the slewing drive 100 may control movement of the panel system 150 by tilting its plane when deployed in a vertical manner. In this configuration, it may be desirable to incorporate a second slewing drive 110 affixed horizontally to the mast 70. The second slewing drive 110 would then be able to rotate the mast 70 to effectively provide horizontal manipulation of the panel system 150.

The slewing drives 100, 110 may be operated manually by a user, passively through use of a compressed gas fluid driven to a particular portion of the slewing drive 100, 110, or actively through the use of motors and gears. Actively operated slewing drives 100, 110 may be connected to a computer system capable of using sensors, date and time-based algorithms, or a combination of both to detect and automatically track the sun's position.

The panel system 150 comprises a plurality of solar panels 160, 162, 164, 166, 168, 170, 172, 174. The embodiment depicted incorporates eight solar panels 160, 162, 164, 166, 168, 170, 172, 174 as this is the maximum number of standard sized panels easily contained on a utility trailer of standard size in the configuration described herein.

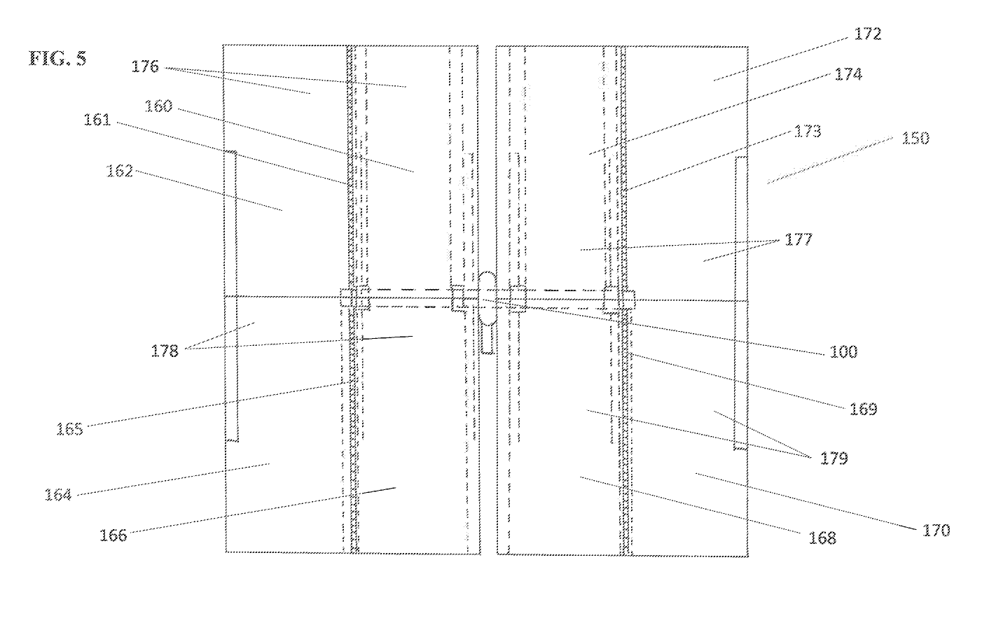

FIG. 2 depicts the portable solar power system 10 in transportation mode. FIGS. 1, 3, and 4 depict the panel system 150 deployed such that the solar panels 160, 162, 164, 166, 168, 170, 172, 174 are in a diagonal orientation. FIG. 5 depicts the panel system 150 deployed such that the solar panels 160, 162, 164, 166, 168, 170, 172, 174 oriented in a position substantially parallel to the ground; certain aspects of the panel manipulation system are shown in broken lines.

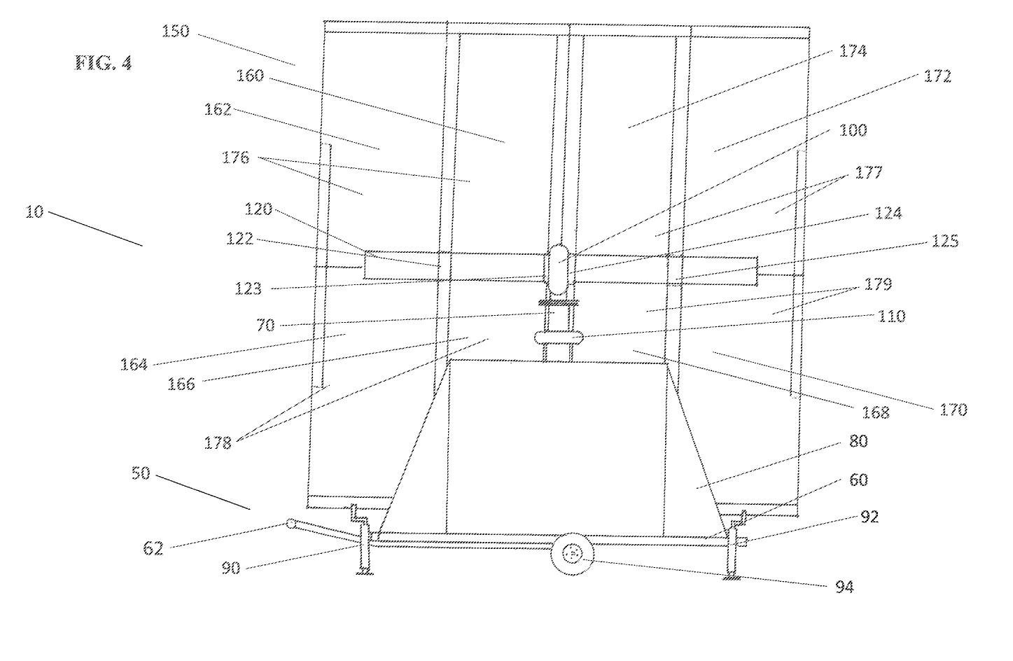

The solar panels 160, 162, 164, 166, 168, 170, 172, 174 comprising the panel system 150 can be connected in a number of ways to each other and to the panel system axle 120. As shown embodiments depicted in FIGS. 1 and 5, there may be four separate pairs of panels 176, 177, 178, 179 that are not directly connected to each other as each set is separately attached to the panel system axle 120. In the embodiment depicted in FIG. 4, the pairs of panels 176, 177 shown tilted higher are connected to each other and the first and the pairs of panels 178, 179 shown tilted lower are all connected.

Certain portions of the panel system 150 are hingably attached to one another through connection of their associated support struts (not shown) to hinges. In the embodiment depicted in FIGS. 1-5, certain portions of the panel system 150 are hingably attached to one another in two different ways.

First, each pair of panels 176, 177, 178, 179 is hingably attached by attaching their respective support struts located closer to the mast 70 to the hinged panel system axle 120. This allows for each pair of panels 176, 177, 178, 179 to be folded down toward the base 80.

The solar panels 160, 162, 164, 166, 168, 170, 172, 174 are also hingably attached to each other within their pairs of panels 176, 177, 178, 179. As can be seen in FIGS. 2 and 5, hinge 161 connects solar panel 160 to solar panel 162, hinge 165 connects solar panel 164 to solar panel 166, hinge 169 connects solar panel 168 to solar panel 170, and hinge 173 connects solar panel 172 and solar panel 174. The hingable attachment may be accomplished through the use of one large hinge, such as a piano or continuous hinge, as shown or several smaller hinges. When fully open, these hinges 161, 165, 169, 173 allow for the solar panels 160, 162, 164, 166, 168, 170, 172, 174 to be in an essentially flat plane for capturing the sun's rays. When closed, these hinges 161, 165, 169, 173 allow the solar panels 162, 164, 170, 172 further from the mast 70 to be folded in toward and on top of the solar panels 160, 166, 168, 174 located closer to the mast 70. When all of the solar panels 160, 162, 164, 166, 168, 170, 172, 174 are folded in on one another and down toward the base 80, the portable solar power system 10 shall be prepared for transportation such as is shown in FIG. 2.

While the hinge connections between the solar panels 160, 162, 164, 166, 168, 170, 172, 174 may be sufficient to position the panel system 150, it may be preferable to incorporate an additional mechanism for securing the panel system 150 in place when deployed. In certain embodiments of the portable solar power system 10, a system of interlocking support rods fixed to the support struts may be used to lock one solar panel to another in a pair and/or to lock one set of solar panels to another set of solar panels. When fully utilized throughout the support system of the panel system 150 in full deployment mode, the interlocking support rods may be used to lock each of the solar panels 160, 162, 164, 166, 168, 170, 172, 174 securely in place.

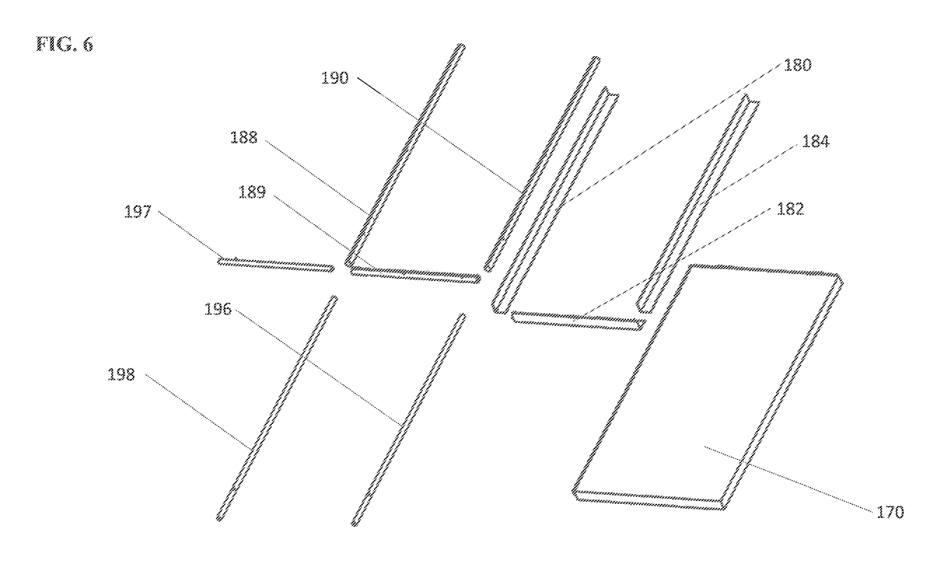

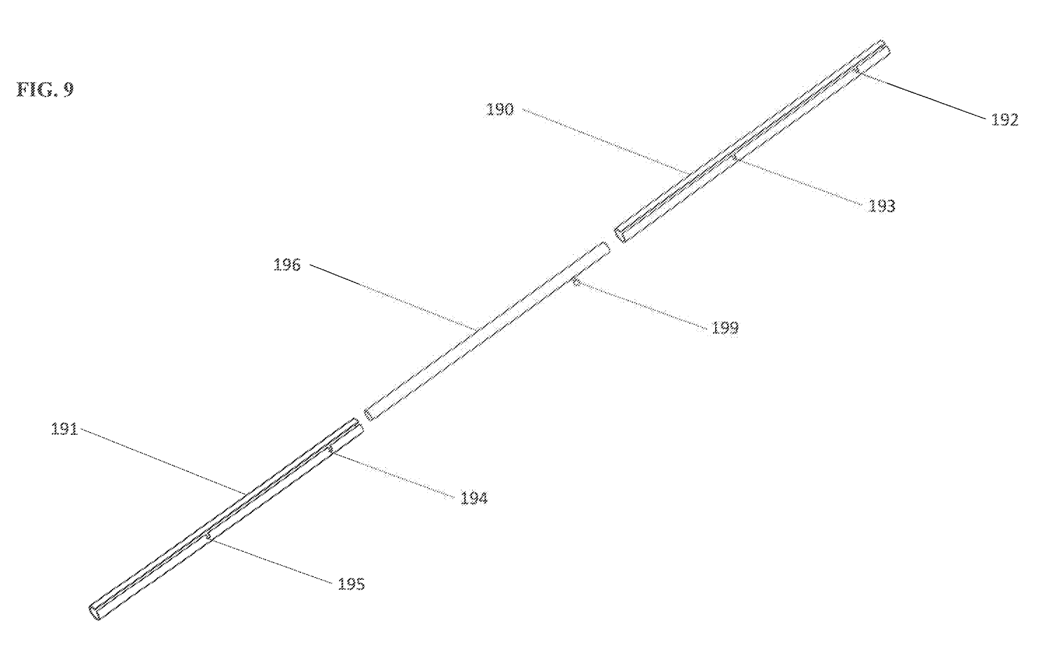

As shown in an exploded view in FIG. 6 for a single solar panel 170, there may be support struts 180, 182, 184 secured to the solar panel 170. Fixed to each of the support struts 180, 182, 184 are outer structural support rods 188, 189, 190. Inner structural support rods 196, 197, 198 may be slidably inserted into the outer structural support rods 188, 189, 190. As more clearly shown in FIG. 9, two outer support rods 190, 191, which would each be attached lengthwise to a separate solar panel (not shown), may comprise slots 192, 193, 194, 195 and an inner support rod 196 may comprise a knob 199. When the inner support rod 196 is slidably inserted into the outer support rod 190, the knob 199 may be used in either of the slots 192, 193 to fix the inner support rod 196 in position. When the inner support rod 196 is inserted such that the knob 199 is fit into the notch 192 closer to an end of the outer support rod 190, the inner support rod 196 is fully encased within the outer support rod 190. In this position, the inner support rod 196 will not impede the positioning of the solar panel (not shown) to which the outer support rod 190 is attached. When the two solar panels attached to the outer support rods 190, 191 are fully deployed, the inner support rod 196 may be inserted into both outer support rod 190 and outer support rod 191 with the knob 199 fit into the notch 193 further from the end of the outer support rod 191, thus locking in place the solar panels to which the outer support rods 190, 191 are attached.

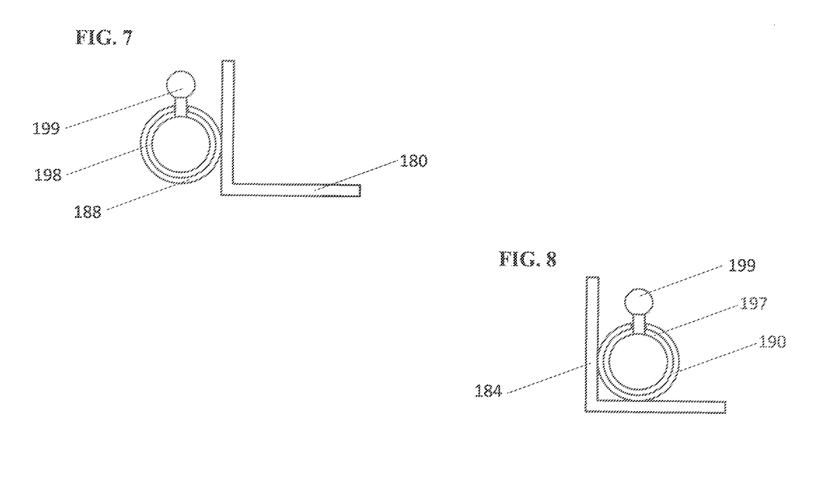

As shown in detail in FIGS. 7-8, the interlocking support rods may be variably positioned with respect to the portion of the support system upon which they are placed. This may be necessary depending on the configuration of the panel system axle 120 as it attaches the support system of the panel system 150 to the slewing drive 100. For example, in certain configurations, an outer structural support rod 188 may be attached to an outside edge of a support strut 180. In other configurations, an outer structural support rod 189 may be attached to an inner edge of a support strut 184.

The solar panels of the portable solar power system may be capable of producing DC power. The portable solar power system, thus, may further incorporate an electric system comprising for capturing and storing the DC power. Such a system would include a battery assembly for storing power from the panel system, an inverter for converting the DC power for the panel system or from the batter assembly to AC power, and a power outlet for outputting the AC power, or the DC power from the battery assembly, to an external attachment. The external attachment could be a generator, a controller to supply power to a recreational vehicle such as a camper, or any number of other options.

Those skilled in the art will recognize that modification and adaptions to the invention are possible without departing from the intended scope of the invention. Many variations and modifications may be achieved within the spirit and scope of the invention as described in the appended claims. The components parts and steps of use described herein need not be performed in the order described, and component parts and steps may be added or omitted.

The invention claimed is:

1. A portable solar power system comprising:
a. a panel system comprising a first set of solar panels and a second set of solar panels wherein the first and second set of solar panels are each respectively fixed to a first set of structural supports and a second set of structural supports and wherein the first and second set of structural supports are hingably attached to one another such that the first and second set of structural supports may be folded in an upwardly extending position for transportation or in a substantially extended deployment position for use;
b. a panel manipulation system comprising:
i. a first slewing drive capable of positioning the panel system through at least vertical rotation,
ii. a means for manipulating the first slewing drive,
iii. a panel system axle fixed to the panel system and passing through the first slewing drive, and
iv. a mast of a column-like shape for supporting the panel system and including an upper portion and a lower portion wherein the upper portion is fixed to the first slewing drive; and
c. a support and transport platform for supporting the panel system comprising:
i. a trailer comprising a deck, at least one wheel connected by means of at least one axle to the deck, and a hitch for connecting the support and transport platform to a towing vehicle, and
ii. a base for supporting the panel system and panel manipulation system, affixed to the deck of the trailer, and comprising a top plate, a support plate, an upper portion, and a lower portion wherein the lower portion of the mast passes through at least the top plate and the upper portion of the base and is secured to the support plate.

2. The portable solar power system of claim 1, wherein the base is of either a primarily three-dimension trapezoidal shape or a primarily pyramidal shape.

3. The portable solar power system of claim 1, wherein the panel system axle comprises a tube-on-tube hinge for hingably attaching the first and second set of structural supports and comprising an inner tube portion and an outer tube portion, wherein the first set of structural supports is connected to the inner tube portion and the second set of structural supports is connected to the outer tube portion.

4. The portable solar power system of claim 1, wherein a first set of solar panels and a second set of solar panels each consist of a number of solar panels selected from a group consisting essentially of one, two, three, four, five, and six.

5. The portable solar power system of claim 1, wherein each set of solar panels comprises at least a first and at least a second solar panel wherein the at least a first solar panel is hingably attached to the at least a second solar panel such that the at least a first solar panel may be folded to rest atop the at least a second solar panel for transportation.

6. The portable solar power system of claim 1, wherein the mast passes through the lower portion of the base and the support plate is attached to the deck of the trailer.

7. The portable solar power system of claim 1, wherein the support plate of the base is affixed between the upper portion and the lower portion of the base and lower portion of the base may be used for storage.

8. The portable solar power system of claim 1, wherein the panel system further comprises at least one set of interlocking rods attached to the first set of structural supports and the second set of structural supports and wherein the at least one set of interlocking rods comprises at least two outer rods and at least one inner rod, wherein the at least one inner rod is capable of being locked into at least two positions such that positioning the at least one inner rod in a retracted position within one of the at least two outer rods does not impede positioning of the first and second sets of solar panels attached to the first and second set of structural supports and positioning the at least one inner rod in an extended position through at least a portion of the at least two outer rods would lock in place the first and second sets of solar panels attached to the first and second structural supports in the substantially extended deployment position.

9. The portable solar power system of claim 1, wherein the panel system is capable of producing DC power and wherein the portable solar power system further comprises an electric system comprising:
a. a battery assembly for storing power from the panel system;
b. an inverter for converting the DC power for the panel system or from the batter assembly to AC power; and
c. a power outlet for outputting the AC power, or the DC power from the battery assembly, to an external attachment.

10. The portable solar power system of claim 1, wherein the first slewing drive is selected from a group consisting essentially of one or more of a single axis slewing drive, a dual axis slewing drive, and combinations thereof.

11. The portable solar power system of claim 1, wherein the means for manipulating the first slewing drive is selected from a group consisting essentially of one or more of the means for manual manipulation by a user, the means for passive manipulation through use of a compressed gas fluid, the means for active manipulation through the use of motors and gears, and combinations thereof.

12. The portable solar power system of claim 1, further comprising a second slewing drive attached to the mast and a means for manipulating the second slewing drive capable of turning the mast such that the mast positions the panel system through horizontal rotation.

13. The portable solar power system of claim 10, wherein the means for manipulating the second slewing drive is selected from a group consisting essentially of one or more of the means for manual manipulation by a user, the means for passive manipulation through use of a compressed gas fluid, the means for active manipulation through the use of motors and gears, and combinations thereof.

14. The portable solar power system of claim 1, wherein the portable solar power system further comprises a control system, the control system comprising:
a. a position determination unit for determining a current position of the portable solar power system being deployed; and
b. a controller adaptable for predicting a position of the sun at the current position of the portable solar power system, determining respective actuations for the slewing drive according to the position of the sun as predicted, and controlling the slewing drive to orient the panel system to track the sun according to the respective actuations as determined.

15. The portable solar power system of claim 1, wherein the trailer further comprises at least one outrigger for providing stability and leveling for the portable solar system when immobile.

16. A portable solar power system comprising:
a. a panel system comprising a first set of solar panels and a second set of solar panels wherein each set of solar panels is fixed to a first set of structural supports and a second set of structural supports;
b. a panel manipulation system comprising:
i. a first slewing drive capable of positioning the panel system through at least vertical rotation,
ii. a means for manipulating the first slewing drive,
iii. a panel system axle fixed to the panel system, passing through the first slewing drive, and constituting a tube-on-tube hinge for connecting the first and second set of structural supports wherein the first set of structural supports is connected to an inner tube portion of the tube-on-tube hinge and the second set of structural supports is connected to an outer tube portion of the tube-on-tube hinge such that the tube-on-tube hinge allows the first and second set of structural supports to be folded in an upwardly extending position for transportation or in a substantially extended deployment position for use, and
iv. a mast of a column-like shape for supporting the panel system and including an upper portion and a lower portion wherein the upper portion is fixed to the first slewing drive; and
c. a support and transport platform for supporting the panel system comprising:
i. a trailer comprising a deck, at least one wheel connected by means of at least one axle to the deck, and a hitch for connecting the support and transport platform to a towing vehicle, and
ii. a base of a primarily three-dimension trapezoidal shape for supporting the panel system and panel manipulation system, affixed to the deck of the trailer, and comprising a top plate, a support plate, an upper portion, and a lower portion wherein the lower portion of the mast passes through at least the top plate and the upper portion of the base and is secured to the support plate.

17. The portable solar power system of claim 15, wherein the base is of either a primarily three-dimension trapezoidal shape or a primarily pyramidal shape.

18. The portable solar power system of claim 15, wherein each set of solar panels comprises at least a first and at least a second solar panel wherein the at least a first solar panel is hingably attached to the at least a second solar panel such that the at least a first solar panel may be folded to rest atop the at least a second solar panel for transportation.

19. The portable solar power system of claim 15, further comprising a second slewing drive attached to the mast and capable of turning the mast such that the mast position the panel system through horizontal rotation and a means for manipulating the second slewing drive.

20. The portable solar power system of claim 15, wherein the portable solar power system further comprises a control system, the control system comprising:
a. a position determination unit for determining a current position of the portable solar power system being deployed; and
b. a controller adaptable for predicting a position of the sun at the current position of the portable solar power system, determining respective actuations for the slewing drive according to the position of the sun as predicted, and controlling the slewing drive to orient the panel system to track the sun according to the respective actuations as determined.
